(19) United States
(12) Patent Application Publication
(10) Pub. No.: US 2007/0262495 A1
(43) Pub. Date: Nov. 15, 2007

(54) PRESSURIZED PLASTIC WATER TANK

(76) Inventor: Roger Bitner, Salt Lake City, UT (US)

Correspondence Address: THORPE NORTH & WESTERN, LLP., 8180 SOUTH 700 EAST, SUITE 350, SANDY, UT, 84070, US

(21) Appl. No.: 11/733,128

(22) Filed: Apr. 9, 2007

Related U.S. Application Data
(60) Provisional application No. 60/790,031, filed on Apr. 7, 2006.

(51) Int. Cl. B29D 22/04; B65D 6/28; F16L 55/04

(52) U.S. Cl. 264/574; 141/63; 141/379; 138/30; 220/4.21

(57) ABSTRACT

A device and method is provided for the inline storage of water during pressurized use. The device provides a one-way valve associated with an incoming attachment point of a water tank assuring that water does not flow back through the incoming attachment point. The tank is constructed with two hemispherical caps at the ends connected by a tubular body providing structure when pressurized. The incoming attachment point is connected with the tank near the top preventing backpressure. An outgoing attachment point is connected with the tank as well.

### CROSS-REFERENCE TO RELATED APPLICATIONS AND CLAIM OF PRIORITY

Priority of U.S. Provisional patent application Ser. No. 60/790,031 filed on Apr. 7, 2006 is claimed.

### BACKGROUND OF THE INVENTION

Water tanks and water lines are used for many purposes such as agricultural irrigation, industrial processes, storage, and residential emergency preparedness. There are several forms of water tanks and water lines.

Metal storage tanks, such as stainless steel tanks, usually have at least an outside metal jacket. This jacket serves as a structural support when pressure pushes on the tank walls. The metal can be painted or coated to provide a waterproof barrier. However, over time the barrier can degrade. Openings in the barrier can cause the metal jacket to degrade or rust over time due to oxidation. The process of forming, welding, coating, and shipping metal storage tanks can also make them expensive. Metal water lines can have similar problems.

One type of water line that is used in underground water piping is made from plastic. For example, this plastic piping may be rated for 160 pounds per square inch and it is resistant to corrosion. In addition, the plastic material can be cheaper than metal. However, to form an end for the pipe, a flat plastic end is bolted onto the end of the pipe using flanges and bolts. This flat end is generally weak and may only be able to hold one quarter of the water pressure of the main pipe. For example, the bolted end may be rated at 40 pounds of pressure. This severely reduces the overall system pressure. To counteract this problem, a cement block can be poured into the ground at the end of the line adjacent to the plastic pipe. This cement is expensive and weighs a few hundred pounds. While the use of the cement increases the pressure rating of the pipe, the pressure increase is less than desired and the cement is expensive to install.

Some water storage devices hold water and deliver water based on external water pressure. When the water pressure fails, the tank must be accessed directly to get water. This tank access can be inconvenient and physically demanding, since water must be hauled from the tank to wherever the water is to be used.

Other residential water storage devices are gravity based and must be placed above where the water is required. This requires designing a support structure and placing the storage above where the highest demand for water is. This might require placing the water tank in the highest part of the residence, or even external to the residence.

The water stored in storage tanks can become stagnant when it is not frequently replaced with fresh water. Stagnant water can cause mold and bacteria to form. Chemicals can also leach out of some types of tanks and into stagnant water. The chemicals, mold, and bacteria can degrade the taste and purity of water, which can limit its usefulness as a culinary source.

### SUMMARY OF THE INVENTION

The system and method provides a one-way valve associated with an incoming attachment point of a water tank assuring that water does not flow back through the incoming attachment point. The tank is constructed with two hemispherical caps at the ends connected by a tubular body providing structure when pressurized. The incoming attachment point is connected to the tank near one end. An outgoing attachment point is connected to the tank at another point.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a plastic inline water tank.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Plastic water storage tanks that use thermoplastics like high density polyethylene (HDPE) do not have the same rusting or degradation problems as metal does. Forming plastics can be easier and less expensive than metal. Plastic tanks also tend to be lighter than a metal tank. However, prior plastic tanks do not handle pressure as well as metal tanks. Rapid changes in pressure and/or high fluid pressure can cause plastic structures to fail. For example, the flat ends that are typically bolted onto the ends of plastic piping do not withstand the desired high levels of pressure.

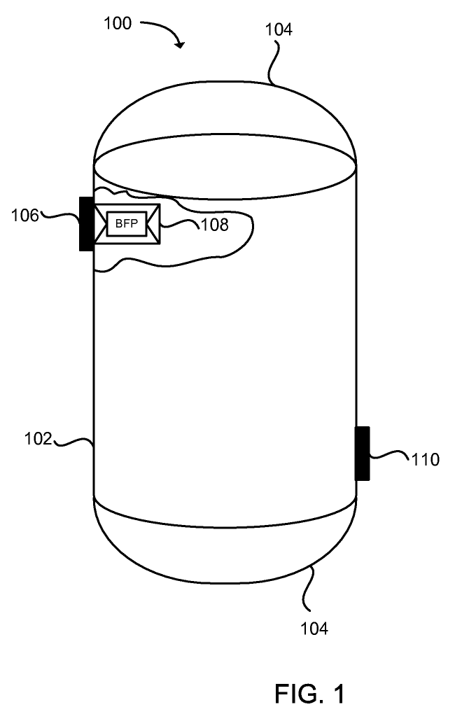

The present system and method provides a plastic pressurized inline water storage tank. As illustrated in the drawing in FIG. 1, one embodiment of the present invention may include a plastic inline water tank 100 comprising a tank body 102, one or more hemispherical caps 104, a water inlet 106 near a top portion of the water tank, and an outlet 110.

A backflow-preventer 108 can also be included that comprises a one-way valve configured to stop water in the plastic inline water tank from flowing out through the inlet. The outlet can be placed at a location near a bottom of the tank body to encourage the water within the tank to be replaced when new water flows into the inlet.

Water is described as the main fluid to be contained with the tank structure. However, other types of fluid can also be contained with the tank such as petroleum based fluids, natural gas, chemicals, acids, bases, or other fluids.

In accordance with an embodiment, water can flow through the inlet 106 near the first of the tank to enable backpressure on the valve caused by the weight of the water and incoming supply to be reduced. Since the water supply can flow from the first end of the tank at the inlet to the second end of the tank at the outlet 110, the tank water is exchanged as it is used, substantially preventing water from stagnating within the tank. In case of a loss of water pressure at the inlet, the plastic inline water tank 100 can store the water within the tank without allowing water through the backflow-preventer device 108. The backflow-preventer device can ensure that a water source used to supply the tank will not siphon off tank water when the main pressure fails. The backflow-preventer can also help the main system remain substantially free from any impurities that may come from the down line fluid circuit.

The hemispherical caps 104 can substantially increase the pressure at which water is stored within the plastic inline water tank 100 by distributing the stresses during pressurization. This is due to the strength of the hemisphere shape that is used. Enabling higher water pressure within the tank can increase the usefulness of the tank. For example, increased pressure can allow the tank to be connected to a high pressure system. The cost of the tank can also be reduced since expensive pressure reduction means are not necessary.

The tank body 102 and hemispherical caps 104 can be constructed as one unit with the body or joined from separate parts. This construction can include typical plastic molding techniques including blow molding, extrusion blow molding, injection blow molding, stretch blow molding, and rotational molding. If the tank body and hemispherical caps are constructed separately, they may be joined through mechanical joints, heat fusion welding, or solvent joining. The hemispherical caps may also include a flange or a section of material that is the same shape as the tank body to enable the cap to be more easily joined to the body.

The attachment points for the inlet 106 and outlet 110 can be included in the construction of the tank, or constructed after the tank construction is complete. These attachment points can include a threaded or unthreaded hole in the tank in which water delivery may be attached or a tube or pipe can protrude from the tank. These attachment points can be configured to accept connections that are made from ductile iron, high density polyethylene (HDPE), medium density polyethylene (MDPE), concrete, copper, cross linked polyethylene (PEX), polyvinyl chloride (PVC), or other delivery pipe types. In one embodiment, if the incoming attachment is placed at a point near the top of the tank, the backpressure caused by the water weight in the tank on the incoming water supply can be reduced.

The one-way valve 108 associated with the incoming attachment point can be external or internal to the tank. The valve can include a pressure sustaining valve or a check valve. The pressure sustaining valve prevents water-hammer (sudden changes in water pressure on water delivery hardware) at the restart of water pressure to the incoming attachment point. The pressure sustaining valve and check valve also prevent water outflow from the incoming attachment point while allowing pressure to be introduced into the tank from another source. The check valve may not prevent initial water pressure loss.

While the tank body structure is tubular in form, it may be modified to prevent rolling of the tank. This modification can be accomplished by an external addition such as a stand, cage, or blocks; an internal addition such as a bolt hole, flat bottom, feet, flanges or stand receptacle, or a combination of both.

In case of water pressure loss, the tank may need to become pressurized. One solution to pressurization is that an air bladder may be included inside the tank. This may be integral to the tank, or may be placed in the tank as an option. The air bladder allows air pressure to provide pressure on the water without dissolving gasses into the stored water.

In case of water pressure loss, the tank may need to be directly accessed to receive water. Such access can be accomplished by a spigot, valve, or other water control device. An air intake device may be necessary to allow air into the tank while the water is being drained. Either of these devices may be integrally formed into the tank or have corresponding attachment points similar to the incoming and outgoing attachment points.

By using plastic, placing the tank in line with water pressure, constructing hemispherical caps, and inserting a one-way valve into the water inlet, this invention overcomes the disadvantages of metal degradation, gravity based requirements, stagnant water, tank fracture, and water pressure loss. Stagnant water is avoided by the invention being in line with the water service, causing fresh water to flow in and the stored water to flow out for water demand.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method of manufacturing a plastic pressurized inline water storage tank, comprising:
constructing hemispherical caps;
combining the hemispherical caps with a tubular body to become a tank;
constructing an incoming attachment point near a first end of the tank;
constructing an outgoing attachment point on the tank; and
coupling a one-way water inlet valve with the incoming attachment point to prevent water escaping through the incoming attachment point.

2. The method of claim 1, wherein the combining the hemispherical caps step further comprises modifying the tank to prevent rolling of the tank.

3. The method of claim 1, wherein the hemispherical cap further comprises a section of material shaped to match the tubular body.

4. A plastic pressurized inline water storage tank, comprising:
hemispherical caps;
a tubular body fused to the hemispherical caps;
a water inlet located near a first side of the tank and having a corresponding attachment point;
a water outlet with a corresponding attachment point; and
a one-way water inlet valve associated with the water inlet for the tubular body.

5. The tank according to claim 4, further comprising a bladder that can be filled with air to pressurize the tank in case of water pressure failure.

6. The invention according to claim 4, further comprising a pressure insertion valve coupled to the tank.

7. The invention according to claim 6, further comprising a separate attachment point on the tank for the pressure insertion valve.

8. The invention according to claim 2 further comprising a tank stand preventing rolling of the tank.
